(19) United States
(12) Patent Application Publication
(10) Pub. No.: US 2010/0050505 A1
(43) Pub. Date: Mar. 4, 2010

(54) Anchorless edging strip

(76) Inventor: Daniel G. Zwier, Holland, MI (US)

Correspondence Address: FLYNN THIEL BOUTELL & TANIS, P.C., 2026 RAMBLING ROAD, KALAMAZOO, MI, 49008-1631, US

(21) Appl. No.: 12/381,712

(22) Filed: Mar. 16, 2009

Related U.S. Application Data
(60) Provisional application No. 61/190,858, filed on Sep. 3, 2008.

(51) Int. Cl. A01G 1/08

(52) U.S. Cl. 47/33

(57) ABSTRACT

A landscape edging system includes an elongate edging strip having first and second mutually perpendicular plate-like members forming an L-shape. The first plate-like member extends coextensively with the second plate-like member and is configured to lie parallel with an upwardly facing surface of a landscaping surface upon which it has been placed. A further plate-like member is oriented either above or below the first plate-like member. Plural fastening members fasten the first plate-like member to the further plate-like member to facilitate clamping of a porous material layer therebetween to facilitate a fixed orientating of the edging strip relative to the landscape surface on which the edging strip has been placed.

### CROSS REFERENCE TO RELATED APPLICATION

This application claims the benefit of U.S. Provisional Application Ser. No. 61/190,858, filed Sep. 3, 2008, which is incorporated herein by reference in its entirety.

### FIELD OF THE INVENTION

This invention relates to an edging strip for use in various landscaping environments, particularly those that do not permit the use of anchors for anchoring the edging strip to a supporting surface directly beneath the edging strip.

### BACKGROUND OF THE INVENTION

This invention arose in an environment where vegetation is located on roofs of structures, which applications are known in the field as green roof applications. In these environments, it is often not possible to secure edging strips directly to the building roof for fear of damaging the roofing surface causing leakage of water through the roof into the interior of the building.

### BRIEF DESCRIPTION OF THE DRAWINGS

Other objects and purposes of this invention will be apparent to persons acquainted with apparatus of this general type upon reading the following specification and inspecting the accompanying drawings, in which:

FIG. 1 is an isometric view of the edging strip embodying the new invention;

FIG. 2 is a top view thereof;

FIG. 3 is an edge view of the edging strip;

FIG. 4 is an isometric view of an arcuate formation of the edging strip;

FIG. 5 is an isometric view of an inside corner formed by the edging strip;

FIG. 6 is an isometric view of an outside corner formed by the edging strip;

FIG. 7 is an isometric view of an edging strip embodying the invention being used with a geo grid fabric;

FIG. 8 is a side view of a pair of edging strips that are connected end to end;

FIG. 9 is an alternate environment for the inventive edging strip;

FIG. 10 is an isometric view of the edging strip embodying the invention and a plate clamping the porous material layer (geo grid) therebetween;

FIG. 11 is an isometric view of a modified capture plate operatively connected to the edging strip and the porous or geo grid layer;

FIG. 12 is an isometric view of a further modified capture plate;

FIG. 13 is an isometric view of a further modified capture plate;

FIG. 14 is an isometric view of a still further modified capture plate; and

FIGS. 15-18 are each an isometric view of the respective modified capture plates of FIGS. 11-14 but with plural upstanding barbs on one face of the respective capture plate.

### DETAILED DESCRIPTION

A portion of a section of elongated edging strip 10 made of extrudable or similar formable material, such as but not limited to aluminum, and embodying the invention is illustrated in the drawings. The edging strip 10 has an L-shape which includes a generally horizontal plate-like base leg member 11 and a vertically upstanding plate-like leg member 12 oriented approximately 90° to the base leg. The base leg 11 and the vertical leg 12 have ribbing thereon forming raised sections 13 and recessed sections 14 extending coextensively with the length of each section of edging strip.

Adjacent the terminal edge 16 of the base leg 11 there is provided a channel 17 defined by upstanding wall sections 18 and 19. The wall section 18 has a generally horizontally extending flange 21 extending toward the wall section 19 parallel to the plane of the base leg. Similarly, the wall section 19 has a generally horizontally extending flange 22 extending toward the wall section 18 parallel to the plane of the base leg. In this particular embodiment, the floor 23 of the channel 17 has a raised section 13 therein that occupies a majority of the floor space.

Adjacent the terminal edge 24 of the vertical leg 12 there is provided a channel 26 defined by upstanding wall sections 27 and 28. The wall section 27 has a generally vertically extending flange 29 extending toward the wall section 28 parallel to the plane of the vertical leg. Similarly, the wall section 28 has a generally vertically extending flange 31 extending toward the wall section 27 parallel to the plane of the vertical leg. In this particular embodiment, the floor 32 of the channel 26 may have a raised section 13 therein that occupies a majority of the floor space dependent upon the size of the profile.

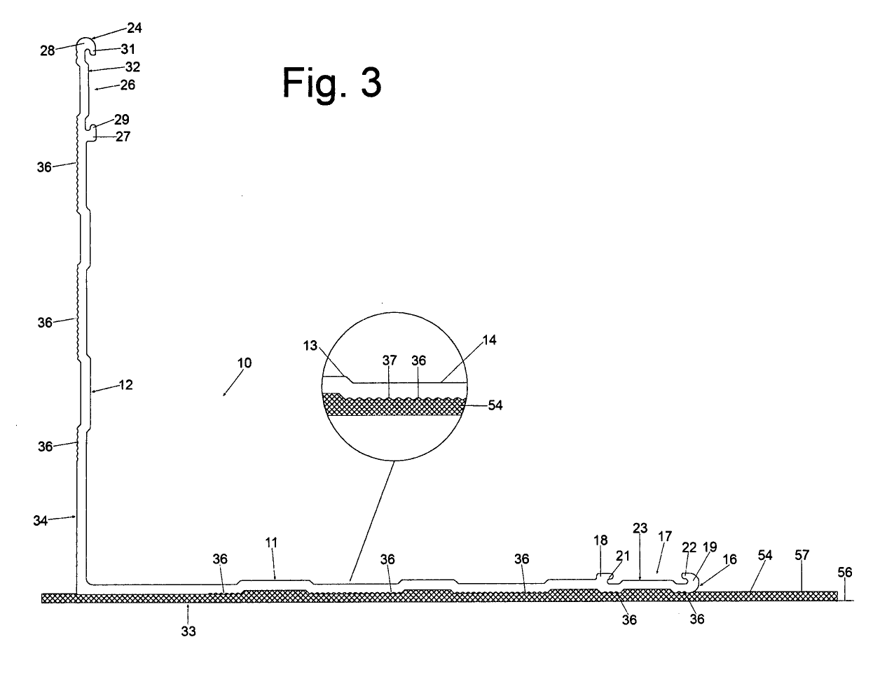

The bottom facing surface 33 of the base leg 11 and the leftwardly (FIG. 3) facing surface 34 of the vertical leg of the L-shaped edging strip 10 each have serrated surfaces as at 36. While the serrations may be of any convenient style, the serrations 36 in this particular embodiment are longitudinally extending, closely spaced, scorings 37 or any abrasive configuration. The scorings 37 are oriented on surface segments that are opposite the sides of the channels 17 and 26.

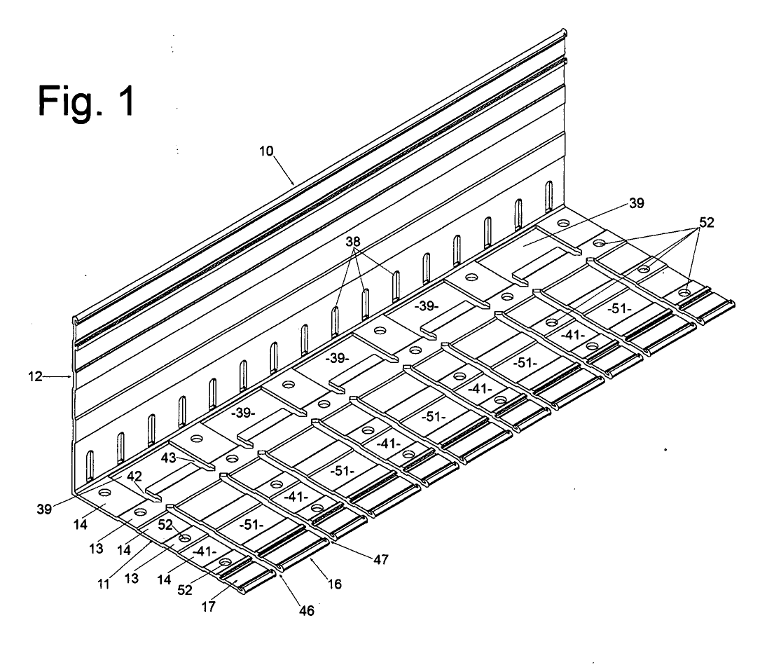

FIG. 1 illustrates a plurality of side by side through openings 38 provided in the vertical leg 12 adjacent the juncture with the base leg 11. The openings 38 each have a cathedral-like window shape, namely, a shape where the bottom edge of the opening is straight, the side edges of the opening are straight and the upper edge portion is arch-like. Furthermore, the cross sectional size of these openings are controlled so that a plurality of them per foot of length will allow a certain volume of water to pass therethrough, such as 15 gallons per minute.

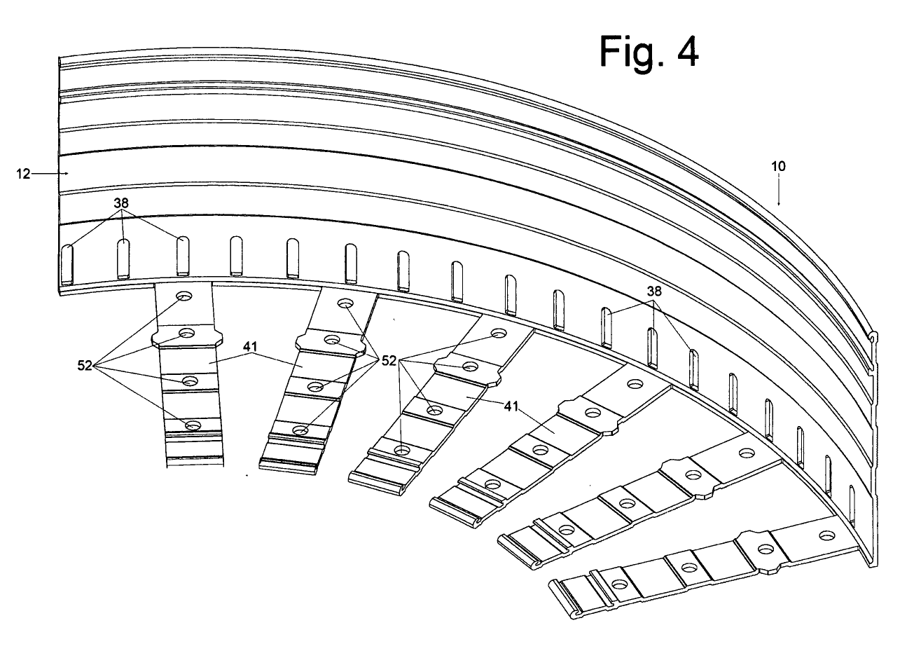

The base leg 11 is configured with a plurality of material removed therefrom as by a stamping process. More specifically, the base leg 11 includes a plurality of rectangular openings 39 wherein each of the openings abuts the juncture with the vertical leg 12. Each of the openings 39 is spaced in a lengthwise direction a distance from one another by a base leg section 41 that extends to the distal edge 16. Each of the openings 39 has a pair of transversely extending slot sections 42 and 43 that each terminate in a V-shaped wall section 44. The base leg 11 is furthermore provided with transversely extending slots sections 46 and 47 that are aligned with the slot sections 42 and 43. The slot sections 46 and 47 are open ended at the distal edge 16 of the base leg. The other ends of the slot sections 46 and 47 terminate in a V-shaped wall section 49. The lateral space between the slot sections 46 and 47 is defined by a base leg section 51. The transverse distance between the apexes of the V-shaped wall sections 44 and 49 is controlled so as to permit the base leg sections 51 to be manually grasped and flexed upwardly and downwardly relative to the plane of the base leg 11 so as to twist the base leg material to a point of failure allowing the base leg sections 51 to be removed as shown in FIG. 4.

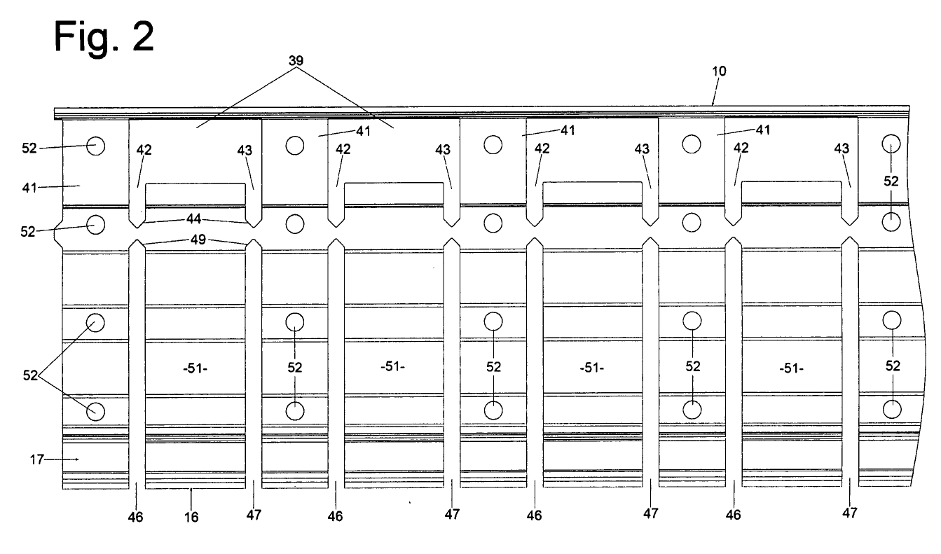

In the embodiment best illustrated in FIG. 2, each of the base leg sections 41 has at least one through hole 52. While the edging strip 10 is capable of use without anchoring spikes or anchors, it is sometimes preferable to insert anchoring spikes or anchors into selected ones of the holes 52 to anchor the edging strip 10 to a supporting surface to prevent movement of the edging strip relative to the supporting surface.

FIG. 3 illustrates the provision of a waterproof membrane 54 made of a polymer, such as rubber. The membrane 54 is placed onto a roof surface 56 in applications known as “green roof” applications. The edging strip 10 embodying the invention is thereafter placed onto the upwardly facing surface 57 of the membrane 54 so as to cause the upper surface of the membrane to conform to the shape of the serrations 36 to serve the purpose of preventing the edging strip 10 from moving laterally relative to the membrane.

When some or all of the base leg sections 51 are manually removed in the field as depicted in FIG. 4, the vertical leg 12 can be formed into an arc.

The base design is specifically configured to allow the base leg sections 51 to be removed manually eliminating the need to use a saw or other cutting device on the roof surface which may produce metal shavings, chips, scrap or other debris capable of damaging the integrity of the roof membrane.

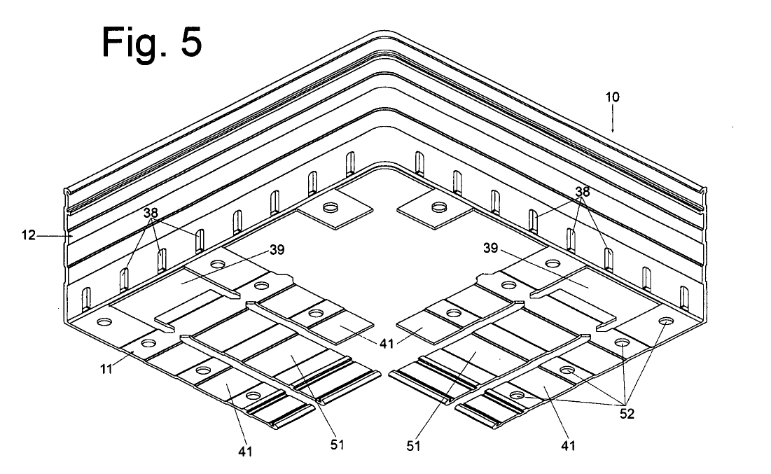

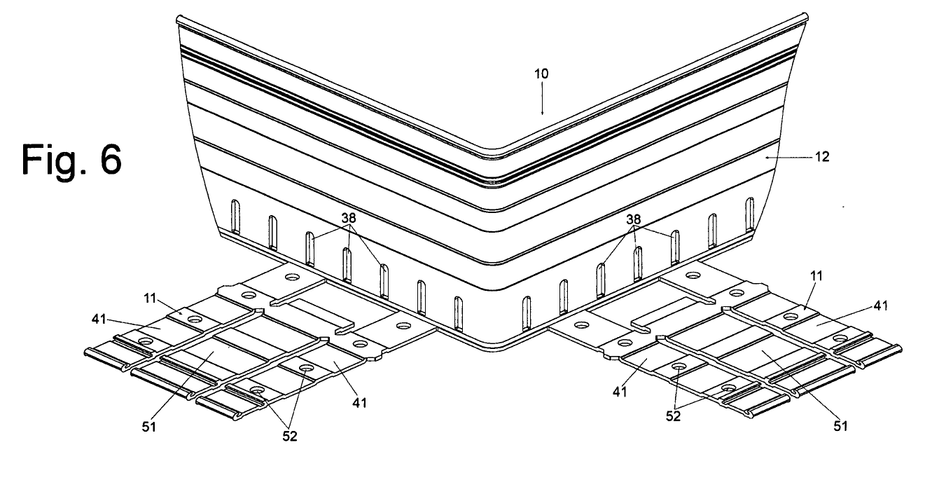

When selected base leg sections 41 and 51 have been manually removed in the field as depicted in FIG. 5, the vertical leg 12 can be formed into what is known in the field as an inside angle, an angle of 90° being illustrated in FIG. 5. Similarly, the vertical wall 12 can be formed into what is known in the field as an outside angle, an angle of 90° being illustrated in FIG. 6.

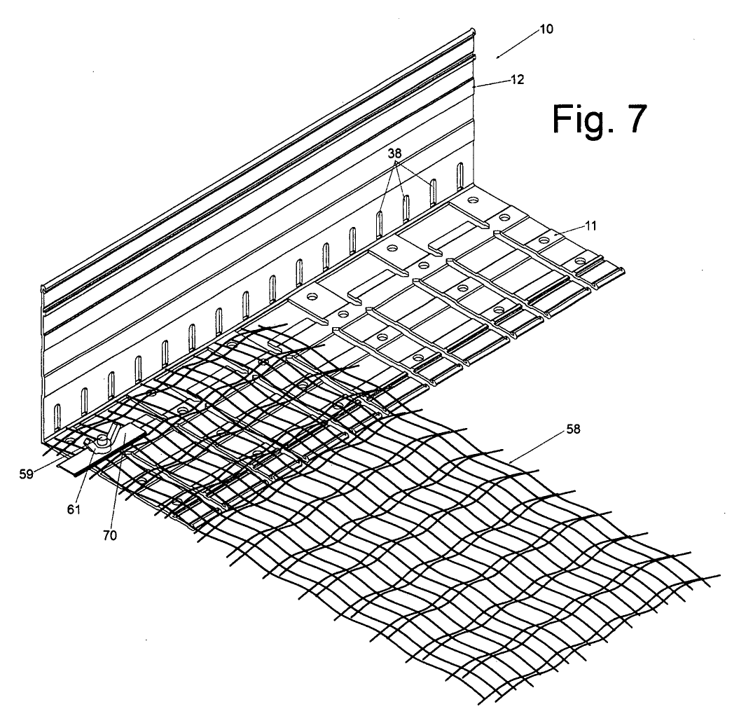

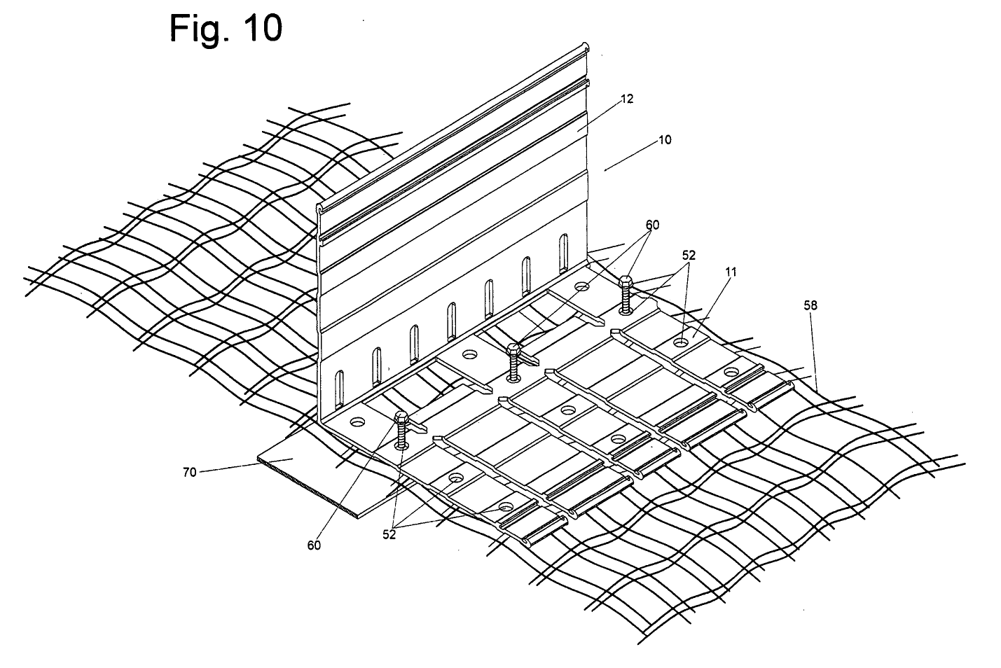

FIG. 7 illustrates an application where a conventional geo grid fabric 58 is used in a situation where it is desired to anchor one edge of the fabric (not shown) under the ballast material or to a fixed member and overlaying the opposite edge of the fabric over the upper surface, or under the surface, of the base leg 11 of the edging strip 10 as depicted in FIG. 7. In the alternative (FIG. 10), the porous material layer or geo grid material 58 can be clamped between a base (stem) 11 of the restraint 11 and an elongate capture plate 70 extending coextensively with the restraint 11. Plural self-tapping screws 60 are utilized for drawing the plate 70 and the base 11 together to clamp the porous material layer or geo grid material therebetween. It is to be recognized that the plate 70 can be oriented above the base 11 or below it (as shown in FIG. 10) in order to achieve a stable connection of the geo grid material to the edge restraint 11 so as to provide a stable orientation of the restraint relative to the ground or bed upon which the restraint and porous material layer or geo grid material are place.

In the alternative, a fastening or capture plate 70 (FIG. 7) can be used to trap or clamp the porous material layer or geo grid fabric to the base leg 11. A fastening member, such as a conventional nut and bolt, is used by inserting the bolt 59 from the bottom side of the base leg 11 up through a selected hole 52 to penetrate the fabric and a hole in the capture plate 70. The nut 61 is secured to the bolt 59 to trap or clamp the fabric between the base leg 11 and the fastening plate or member.

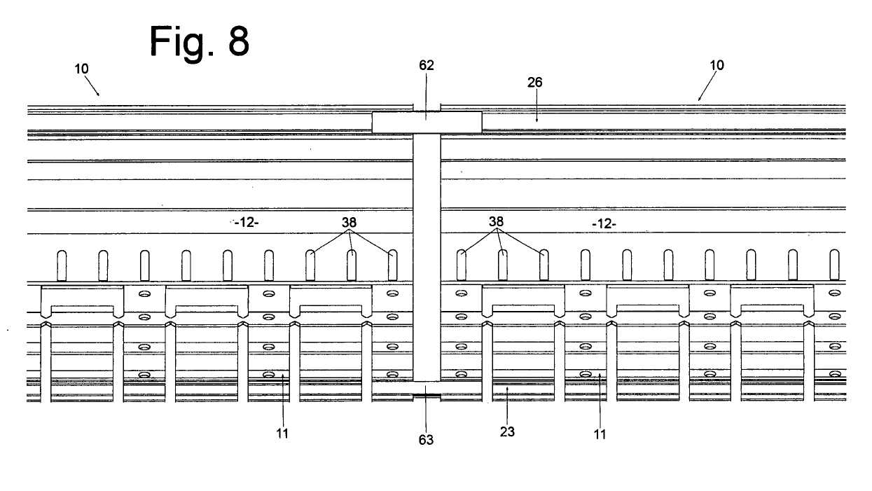

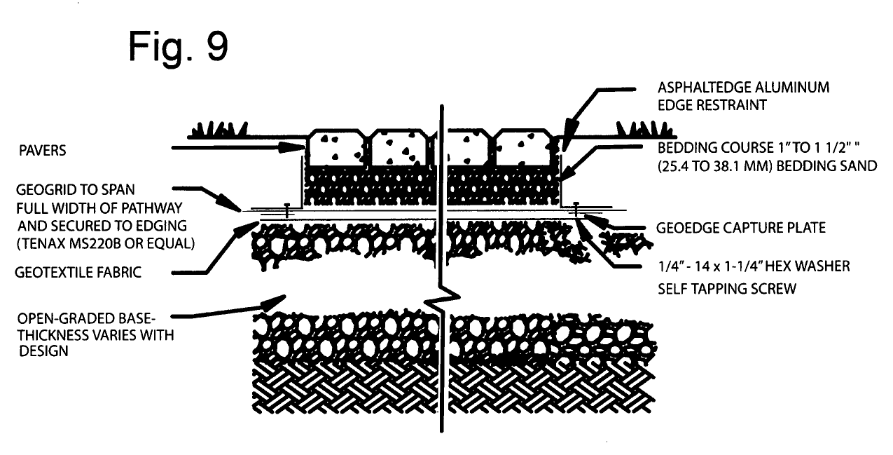

A pair of mutually adjacent ends, such as depicted in FIG. 8, of two adjacent edging strips 10 can be secured together utilizing an elongate connector bar 65 which is configured to be received into axially aligned channels 26 in the adjacent vertical legs 12. If desired, a further elongate connector bar 63 is configured to be received into axially aligned channels 17 in the adjacent base legs 11. As the ends of the adjacent edging strips 10 are brought together, a tool can be used to deform or cold work one or more deformations into the respective connector bars 62 and 63 and the floors 23 and 32 to interlock the bars and floors together to prevent a relative movement between the connector bars 62 and 63 and the respective channels 17 and 26.

Once the edging strips 10 have oriented end to end so that the side of the vertical legs 12 remote from the base legs 11 form a barrier or an edge for growing media for plant life, ballast in the form of non-compactable material in the form of growing media, stone and the like is placed onto the upper surface of the base leg 11 to force the serrations into the material of the membrane 54 that is secured to the roof to cause the edging strip to become incapable of relative lateral movement with respect to roof surface. In installations of this type, the base leg 11 is variable from about 2 inches up to 12 or more inches in length dependent upon specific application and the vertical leg is also variable from about 2 inches up to 12 or more inches in height again dependent upon the specific application requirements.

This invention also has other applications not associated with green roof applications, such as porous pavement applications. More specifically, to date the approach to retention of porous pavement installation is a heavy poured concrete curb. Although it's performance is relatively acceptable, this methodology has significant drawbacks.
1. A porous pavement installation utilizing poured concrete curb takes considerably longer in that the curb must be formed, allowed to cure, followed by removal of the forms. This delay of at least two to three days forces the contractor to either remove his excavation equipment from the site or retain it on site potentially sitting idle. This chronological extension of the installation process unduly increases the cost of the installation.
2. Layered installation of the aggregate materials following the forming of the poured concrete curb creates a delicate balance between effectively vibra-compacting of the aggregate several times using heavy equipment and this vibratory compaction process damaging the concrete curb designed to retain it. The proper amount of time needed to fully cure concrete is not achieved prior to the vibratory layered installation of the aggregate.
3. The nature of porous “open-graded” base materials (crushed stone with no small or fine particles) is that regardless of the initial attempts at compaction, settling will occur over the life of the installation. The drawback to poured concrete curb which is poured over undisturbed or fully compacted adjacent parent material is that it will inevitably result in uneven rates of settling or movement where the pavement surface and poured concrete curb or other restraint requiring anchoring into undisturbed or fully compacted adjacent material meet. An uneven rate of movement may also be caused by frost heave producing movement of the curb or restraint installed or anchored into adjacent material independent of the porous pavement surface.
4. It results in an unsightly heavy border, visually undesirable in many applications.

This system is installed in process following excavation and the majority of the vibratory installation processes;
1. Significantly lessening the time required for the installation process, resulting in significant cost reductions.
2. Serves as a horizontally integrated system acting in concert with the active function of the system.
3. Floats independently as part of a dynamic system as opposed to a fixed, inflexible, independent perimeter device.
4. The perimeter location of the restraint system is not restricted to the edge of the installation where compacted “open-graded” base material meets the undisturbed adjacent landscape. Perimeter location of my restraint is not necessary for anchoring or securing in place. This freedom to locate the perimeters of the porous paver roadways or walkways at any location over the subsurface water system, be it natural or man made, vastly increases the design flexibility between these two elements.

A free floating Dead Man system that is installed on and captured by non-compactable aggregate materials.

The interface between an inner retention structure (optional), geotextile grid and an outer restraint that work in concert with each other.

Conventional Dead Man systems derive their effectiveness by incorporating compactable overbearing materials of sufficient enough depth, weight and compactibility to serve as a continuous lateral/horizontal retention mechanism. In most cases, the inner anchoring structure relies almost exclusively on its ability to retain itself by vertically anchoring itself into undisturbed or significantly compactable disturbed soil.

This invention sometimes can benefit neither from the weight, depth or compactibility given the relative minimal overlying depth resulting in minimal overbearing weight and inherent non-compactibility of materials used. In addition, the non-compactable nature of the aggregate that my system is installed over negates any effective opportunity for vertical anchoring associated with either the inner or outer restraint structure.

Effective vertical system stability coupled with horizontal retention and stability in the retention and integrity of the overlying load bearing surface is the ultimate goal. This system achieves this goal within an environment where layers of “open-graded” base material (crushed stone layers with no small or fine particles) of uniform size are load bearing yet porous. The load bearing yet porous nature of the “open-graded” base material prohibits effective anchoring with conventional downward perimeter anchoring such as spikes. The integral functioning of my system effectively interfacing surface material (pavers), “open-graded” base material, geo grid, and restraint allows the macro goal for the installation of rapid downward and horizontal permeability of surface water.

### Alternate Capture Plate Construction

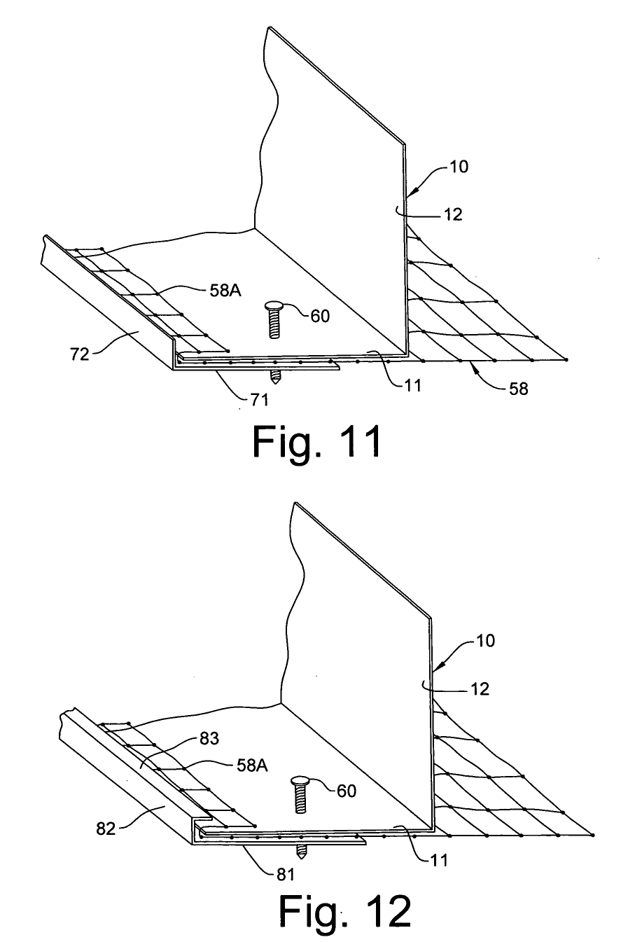

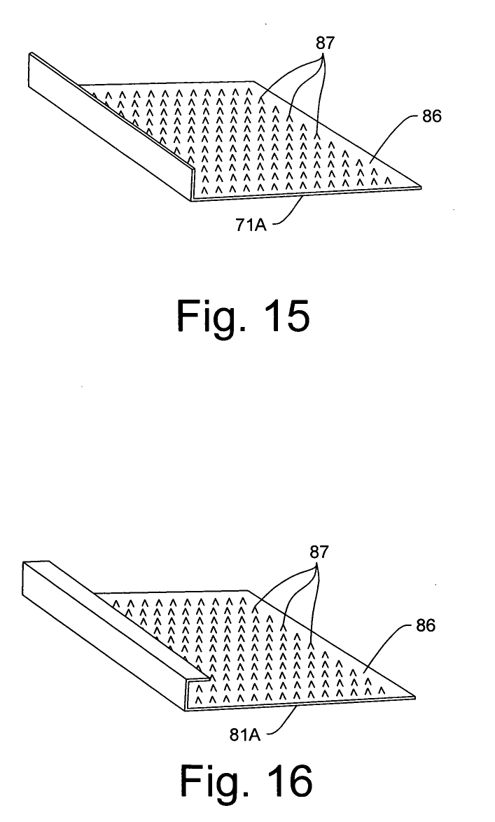

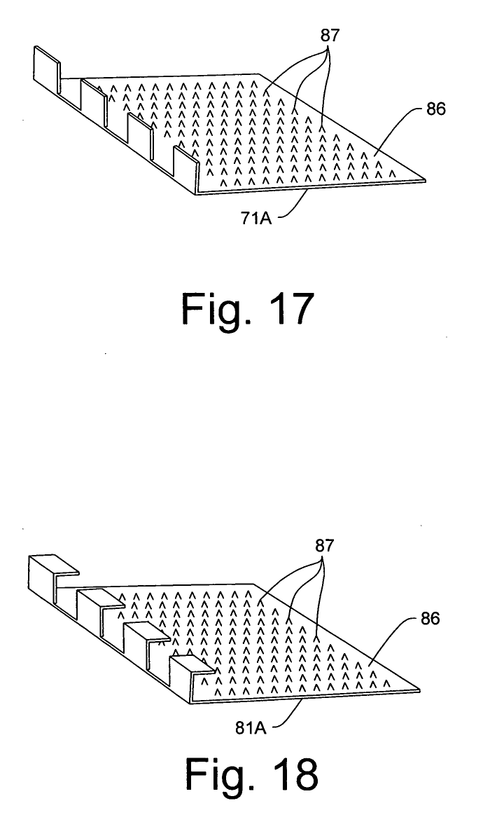

Several modifications of the capture plate 70 shown in FIGS. 7 and 10 are illustrated in FIGS. 11-18.

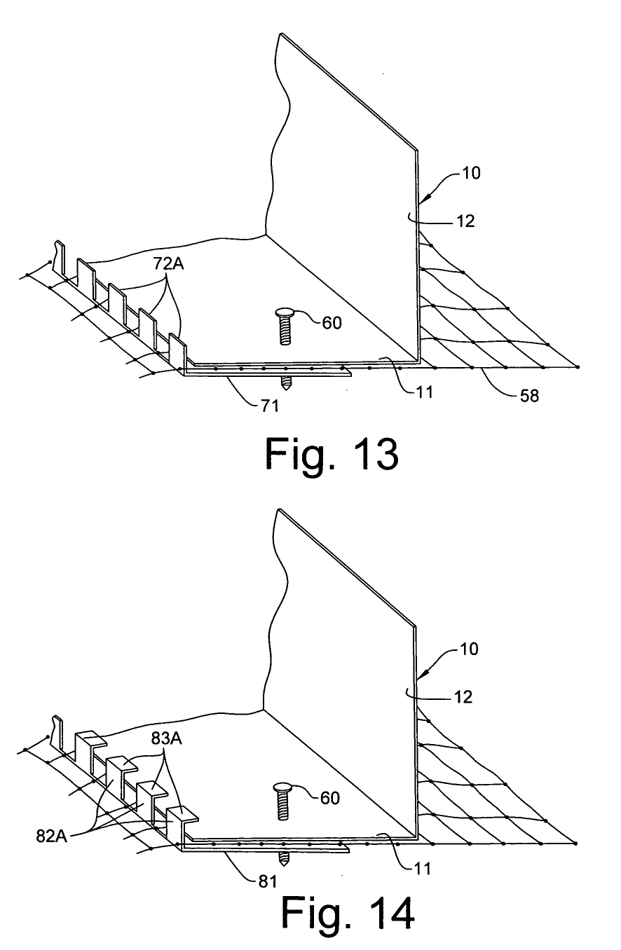

In FIG. 11, the modified capture plate 71 has an upstanding lip 72 along one edge. The porous layer or geo grid layer 58 is placed between the upper surface of the capture plate 71 and the understand of the base leg 11 of the edging strip and an edge 58A of the porous layer of geo grid layer is wrapped over the edge of the base leg 11 and overlays the upwardly facing surface of the base leg as shown in FIG. 11. Plural self-tapping screws 60 are utilized to secure the base leg 11 to the capture plate 71. The upstanding lip 72 serves to prevent relative movement between the edging strip 10 and the porous layer or geo grid layer. FIG. 13 is similar to FIG. 11 except that the lip 72 is separated into multiple upstanding lips 72A configured to enter the open spaces provided in the porous layer or geo grid layer. In the FIG. 13 embodiment, the porous layer or geo grid layer does not overlay the upper surface of the base leg 11 of the edging strip.

In FIG. 12, the modified capture plate 81 has an upstanding lip 82 along one edge. The upper edge of the lip 82 has a flange 83 extending generally parallel to a plane containing the capture plate 81 and toward the vertically upstanding leg 12 of the edging strip 10. The porous layer or geo grid layer 58 is placed between the upper surface of the capture plate 81 and the understand of the base leg 11 of the edging strip and an edge 58A of the porous layer of geo grid layer is wrapped over the edge of the base leg 11 and overlays the upwardly facing surface of the base leg as shown in FIG. 12. Plural self-tapping screws 60 are utilized to secure the base leg 11 to the capture plate 81. The upstanding lip 82 and flange 83 serve to prevent relative movement between the edging strip 10 and the porous layer or geo grid layer 58. FIG. 14 is similar to FIG. 12 except that the lip 82 and flange 83 configuration depicted in FIG. 12 is separated into multiple upstanding lips 82A and flanges 83A in FIG. 14, each configured to enter the open spaces provided in the porous layer or geo grid layer. In the FIG. 14 embodiment, the porous layer or geo grid layer 58 does not overlay the upper surface of the base leg 11 of the edging strip 10.

FIGS. 15-18 each illustrate a modified capture plate that is similar to the capture plates 71 and 81 illustrated in FIGS. 11-14. The upper facing surface 86 of each of the modified capture plates 71A and 81A have plural upstanding barbs 87 or the like that are configured to intermesh with the porous layer or geo grid layer 58 to further prevent relative movement between the edging strip 10 and the porous layer or geo grid layer 58.

It is to be understood that the capture plates can be positioned above the upper surface of the base leg 11 of the edging strip 10 and oriented so that the respective lips project downwardly through the open space in the porous or geo grid layer 58. Plural self-tapping screws would also be utilized to secure the capture plates to the respective base leg 11 of the edging strip 10.

Although a particular preferred embodiment of the invention has been disclosed in detail for illustrative purposes, it will be recognized that variations or modifications of the disclosed apparatus, including the rearrangement of parts, lie within the scope of the present invention.

What is claimed is:

1. A landscape edging system, comprising:
an elongate edging strip having at least first and second mutually perpendicular plate-like members, said first plate-like member extending coextensively with said second plate-like member, said first plate-like member being configured to lie parallel with an upwardly facing surface of a landscaping surface upon which said first plate-like member has been placed, at least said first plate-like member having an alternating pattern of parallel longitudinally extending raised portions and recessed portions on a first surface thereof configured to oppose the landscaping surface, said raised portions having thereon plural closely spaced serrations extending lengthwise of said first plate-like member and being configured to prevent relative movement between said edging strip and the landscaping surface.

2. The landscape edging system according to claim 1, wherein said first plate-like member has plural cut-out slots that extend from a terminal edge thereof toward said second plate-like member.

3. The landscape edging system according to claim 2, wherein said cut-out slots are parallel to one another.

4. The landscape edging system according to claim 3, wherein plural parallel patterns of circular holes are provided in said first plate-like member which are located between a terminal edge thereof and said second plate-like member, said cut-out slots being oriented between said plural patterns of circular holes.

5. The landscape edging system according to claim 2, wherein said first plate-like member has plural rectangular openings abutting the juncture with said second plate-like member, said cut-out slots extending toward said rectangular openings and terminating at a location of controlled material thickness between a terminal end of said slot and said rectangular opening to facilitate a manual breakage and separation of a section of said first plate-like member away from the remainder of said first plate-like member.

6. The landscape edging system according to claim 1, wherein a second surface on said first plate-like member has a pair of upstanding wall sections extending coextensively with the lengthwise extent thereof and defining a channel therebetween.

7. The landscape edging system according to claim 6, a terminal edge of each of said wall sections include a flange extending parallel to a plane of said first plate-like member toward the other wall section.

8. The landscape edging system according to claim 7, wherein said edging strip includes an elongate connector bar configured to be received lengthwise into said channel to facilitate a connection of identical mutually adjacent end-to-end oriented edging strips.

9. The landscape edging system according to claim 8, wherein said first and second plate-like members are identically configured.

10. The landscape edging system according to claim 9, wherein said edging strip is a unitary construction forming an L-shape.

11. The landscape edging system according to claim 1, wherein said edging strip includes a further plate-like member oriented either above or below said first plate-like member and plural fastening members for fastening said first plate-like member to said further plate-like member to facilitate clamping a porous material layer therebetween to facilitate a fixed orientation of said edging strip relative to the landscaping surface on which said edging strip has been placed.

12. The landscape edging system according to claim 11, wherein said porous material layer is a geo grid or other porous material layer material.

13. The landscape edging system according to claim 11, wherein said further plate-like member has an upstanding lip along one edge thereof.

14. The landscape edging system according to claim 13, wherein said upstanding lip has a flange extending parallel to a plane of the further plate-like member.

15. The landscape edging system according to claim 13, wherein said upstanding lip extends coextensively with a longitudinal extent of said further plate-like member.

16. The landscape edging system according to claim 13, wherein said upstanding lip consists of plural and separate upstanding lips longitudinally aligned along said one edge of said edging strip.

17. The landscape edging system according to claim 11, wherein one face of said further plate-like member has plural upstanding barbs over a major surface area thereof.

18. A landscape edging system, comprising:
an elongate edging strip having at least first and second mutually perpendicular plate-like members forming an L-shape, said first plate-like member extending coextensively with said second plate-like member, said first plate-like member being configured to lie parallel with an upwardly facing surface of a landscaping surface upon which said first plate-like member has been placed, and
a further plate-like member oriented either above or below said first plate-like member and plural fastening members for fastening said first plate-like member to said further plate-like member to facilitate clamping of a porous material layer therebetween to facilitate a fixed orientating of said edging strip relative to the landscape surface on which said edging strip has been placed.

19. The landscape edging system according to claim 18, wherein said first plate-like member has plural cut-out slots that extend from a terminal edge thereof toward said second plate-like member.

20. The landscape edging system according to claim 19, wherein said cut-out slots are parallel to one another.

21. The landscape edging system according to claim 20, wherein plural parallel patterns of circular holes are provided in said first plate-like member which are located between a terminal edge thereof and said second plate-like member, said cut-out slots being oriented between said plural patterns of circular holes.

22. The landscape edging system according to claim 20, wherein said first plate-like member has plural rectangular openings abutting the juncture with said second plate-like member, said cut-out slots extending toward said rectangular openings and terminating at a location of controlled material thickness between a terminal end of said slot and said rectangular opening to facilitate a manual breakage and separation of a section of said first plate-like member away from the remainder of said first plate-like member.

23. The landscape edging system according to claim 18, wherein a second surface on said first plate-like member has a pair of upstanding wall sections extending coextensively with the lengthwise extent thereof and defining a channel therebetween.

24. The landscape edging system according to claim 23, a terminal edge of each of said wall sections include a flange extending parallel to a plane of said first plate-like member toward the other wall section.

25. The landscape edging system according to claim 24, wherein said edging strip includes an elongate connector bar configured to be received lengthwise into said channel to facilitate a connection of identical mutually adjacent end-to-end oriented edging strips.

26. The landscape edging system according to claim 25, wherein said first and second plate-like members are identically configured.

27. The landscape edging system according to claim 26, wherein said edging strip is a unitary construction forming an L-shape.

28. The landscape edging system according to claim 18, wherein said edging strip includes a further plate-like member oriented either above or below said first plate-like member and plural fastening members for fastening said first plate-like member to said further plate-like member to facilitate clamping a porous material layer therebetween to facilitate a fixed orientation of said edging strip relative to the landscaping surface on which said edging strip has been placed.

29. The landscape edging system according to claim 18, wherein said porous material layer is a geo grid material.

30. The landscape edging system according to claim 28, wherein said further plate-like member has an upstanding lip along one edge thereof.

31. The landscape edging system according to claim 30, wherein said upstanding lip has a flange extending parallel to a plane of the further plate-like member.

32. The landscape edging system according to claim 30, wherein said upstanding lip extends coextensively with a longitudinal extent of said further plate-like member.

33. The landscape edging system according to claim 30, wherein said upstanding lip consists of plural and separate upstanding lips longitudinally aligned along said one edge of said edging strip.

34. The landscape edging system according to claim 28, wherein one face of said further plate-like member has plural upstanding barbs over a major surface area thereof.
